(19) United States
(12) Patent Application Publication
(10) Pub. No.: US 2024/0309580 A1
(43) Pub. Date: Sep. 19, 2024

(54) ANTIMICROBIAL FINISH FOR TEXTILES

(71) Applicant: UNIVERSITY OF MASSACHUSETTS, Boston, MA (US)

(72) Inventors: Yuyu SUN, Acton, MA (US); Jianchuan WEN, Lowell, MA (US); Nancy GOODYEAR, Lowell, MA (US)

(21) Appl. No.: 18/575,972

(22) PCT Filed: Jul. 19, 2022
(86) PCT No.: PCT/US2022/037536

§ 371 Date: Jan. 2, 2024

Related U.S. Application Data
(60) Provisional application No. 63/224,056, filed on Jul. 21, 2021.

(51) Int. Cl. D06M 16/00; C08F 220/56; D06M 15/263; D06M 15/285; D06M 101/32; G01N 21/78

(52) U.S. Cl. CPC D06M 16/00; C08F 220/56; D06M 15/263; D06M 15/285; G01N 21/78; C08F 2800/10; C08F 2810/20; D06M 2101/32

(57) ABSTRACT

A textile finishing composition includes a copolymer; a water-soluble crosslinking agent comprising an epoxy group; and water. The copolymer includes repeating units derived from a carboxylic acid-containing monomer; and repeating units derived from a polymerizable halamine precursor. The textile finishing composition can be useful for providing finished textiles having antibacterial, antifungal, and antiviral properties.

### CROSS REFERENCE TO RELATED APPLICATION

This application claims priority to U.S. Provisional Patent Application No. 63/224,056, filed on Jul. 21, 2021, in the United States Patent and Trademark Office, and all the benefits accruing therefrom under 35 U.S.C. § 119, the content of which is incorporated herein in its entirety by reference.

### FEDERAL RESEARCH STATEMENT

This invention was made with government support under Grant No. R21OH011406-01A1 awarded by the National Institute of Occupational Safety and Health (NIOSH), Centers for Disease Control and Prevention (CDC). The government has certain rights in this invention.

### BACKGROUND

Textiles are good media for the contamination and survival of pathogenic microorganisms including bacteria, fungi, and viruses. The microorganisms not only reduce the physical and mechanical properties of the textiles but also increase the risk of infections. See, e.g., Wang, F.; Huang, L.; Zhang, P.; Si, Y.; Yu, J.; Ding, B. Composites Communications 2020, 22, 100487; Dhiman, G.; Chakraborty, J. N. Fashion and Textiles 2015, 2 (1), 13; Luo, J.; Sun, Y. J. Polym. Sci., Part A: Polym. Chem. 2006, 44 (11), 3588-3600; Cerkez, I.; Kocer, H. B.; Worley, S. D.; Broughton, R. M.; Huang, T. S. J. Appl. Polym. Sci. 2016, 133 (9), 43088; Nicoloro, J. M.; Wen, J.; Queiroz, S.; Sun, Y.; Goodyear, N. J. Microbiol. Methods 2020, 173, 105937. This poses a significant concern in various applications, particularly the healthcare settings. It has been shown that healthcare fabrics can be heavily contaminated with a large number of pathogenic microorganisms, which survive for weeks and easily spread to the surrounding environments, causing outbreaks of infectious diseases. See, e.g., Mitchell, A.; Spencer, M.; Edmiston, C. J. Hosp. Infect. 2015, 90 (4), 285-292; Neely, A. N.; Maley, M. P. J. Clin. Microbiol. 2000, 38 (2), 724-726; Sattar, S. A.; Springthorpe, S.; Mani, S.; Gallant, M.; Nair, R. C.; Scott, E.; Kain, J. J. Appl. Microbiol. 2001, 90 (6), 962-970; Bearman, G. M. L.; Rosato, A.; Elam, K.; Sanogo, K.; Stevens, M. P.; Sessler, C. N.; Wenzel, R. P. Infect. Control Hosp. Epidemiol. 2012, 33 (3), 268-275; Treakle, A. M.; Thom, K. A.; Furuno, J. P.; Strauss, S. M.; Harris, A. D.; Perencevich, E. N. Am. J. Infect. Control 2009, 37 (2), 101-105; Munoz-Price, L. S.; Arheart, K. L.; Mills, J. P.; Cleary, T.; DePascale, D.; Jimenez, A.; Fajardo-Aquino, Y.; Coro, G.; Birnbach, D. J.; Lubarsky, D. A. Am. J. Infect. Control 2012, 40 (9), e245-e248; Otter, J. A.; Yezli, S.; French, G. L. Infect. Control Hosp. Epidemiol. 2011, 32 (7), 687-699; Snyder, G. M.; Thorn, K. A.; Furuno, J. P.; Perencevich, E. N.; Roghmann. M.-C.; Strauss, S. M.; Netzer, G.; Harris, A. D. Infect. Control Hosp. Epidemiol. 2008, 29 (7), 583-589; Trillis, F.; Eckstein, E. C.; Budavich, R.; Pultz, M. J.; Donskey, C. J. Infect. Control Hosp. Epidemiol. 2008, 29 (11), 1074-1076; Klakus, J.; Vaughan, N. L.; Boswell, T. C. J. Hosp. Infect. 2008, 68 (2), 189-190; Ohl, M.; Schweizer, M.; Graham, M.; Heilmann, K.; Boyken, L.; Diekema, D. Am. J. Infect. Control 2012, 40 (10), 904-906; DeAngelis, D. L.; Khakoo, R. Am. J. Infect. Control 2013, 41 (6, Supplement), S33; Fijan, S.; Turk, S. Š. Int. J. Environ. Res. Public. Health 2012, 9 (9), 3330-3343; Birch, B. R.; Perera, B. S.; Hyde, W. A.; Ruehorn, V.; Ganguli, L. A.; Kramer, J. M.; Turnbull, P. C. B. J. Hosp. Infect. 1981, 2, 349-354; Barrie, D.; Wilson, J. A.; Hoffman, P. N.; Kramer, J. M. J. Infect. 1992, 25 (3), 291-297; Barrie, D.; Hoffman, P. N.; Wilson, J. A.; Kramer, J. M. Epidemiol. Infect. 1994, 113 (2), 297-306; Lazary, A.; Weinberg, I.; Vatine, J. J.; Jefidoff, A.; Bardenstein, R.; Borkow, G.; Ohana, N. Int. J. Infect. Dis. 2014, 24, 23-29.

These findings plus the recent outbreaks of viral pandemics request a rethink of infection control approaches and highlight the need to reduce the microbial burden on healthcare care textiles. Accordingly, there remains a need for improved finishes for textiles to provide durable and rechargeable antibacterial, antifungal, and antiviral functions.

### SUMMARY

A textile finishing composition comprises a copolymer comprising repeating units derived from a carboxylic acid-containing monomer; and repeating units derived from a polymerizable halamine precursor; a water-soluble crosslinking agent comprising an epoxy group; and water.

A finished textile comprising a halamine-containing coating disposed on at least a portion of a surface of a textile, wherein the halamine-containing coating is derived from the textile finishing composition.

A method of finishing a textile, the method comprising: applying the textile finishing composition to the textile; padding the textile; drying the textile, preferably at a temperature of 100° C. or more to provide a coated textile; curing the coated textile under conditions effective to react the crosslinking agent with the carboxylic acid groups of the copolymer, preferably at a temperature of 140° C. or more; and halogenating the coated textile to provide a finished textile having a halamine-containing coating disposed on at least a portion of a surface of the textile.

A method of determining anti-bacterial properties of a finished textile, the method comprising: contacting the finished textile with a compound capable of reacting with a halogen, preferably chlorine, to cause a color change to provide a colorimetric assessment of active halogen content of the finished textile, preferably wherein the compound comprises potassium iodide, diethyl-p-phenylene diamine, and the like, preferably wherein the compound is disposed on a test strip.

The above described and other features are exemplified by the following figures and detailed description.

### BRIEF DESCRIPTION OF THE DRAWINGS

The following figures represent exemplary embodiments.

FIG. 1 is a schematic illustration of a continuous dip-pad-dry-cure-halogenation process for the finishing of textiles according to an aspect of the present disclosure.

FIG. 2 shows a simplified preparation pathway of the N-halamine finished PET, according to an aspect of the present disclosure.

FIG. 3 shows effects of MAAm contents in the copolymers on the percentage add-on and the active chlorine contents of the finished textiles. The finishing bath contained 2.5% of PMA and 2.5% of PEGDGE. The curing temperature was 160° C. and the curing time was 5 minutes.

FIG. 4 shows the effects of the molar ratio of epoxide groups in PEGDGE to the AA moieties in the PMA9-1 copolymer on the percentage add-on and the active chlorine content of the finished textiles. The finishing bath contained 2.5% of PMA9-1. The curing temperature was 160° C. and the curing time was 5 minutes.

FIG. 5 shows the effects of the copolymer PMA9-1 content on the percentage add-on and the active chlorine content of the finished textiles. The molar ratios of epoxide groups in PEGDGE to the AA moieties in the PMA9-1 copolymer were kept at 1.5/1. The curing temperature was 160° C. and the curing time was 5 minutes.

FIG. 6 shows the effects of the curing temperature on the percentage add-on and the active chlorine content of the finished textiles. The finishing bath contained 2.5% of PMA9-1 and the epoxide/AA molar ratio was 1.5. The curing time is 5 minutes.

FIG. 7 shows 5 FT-IR spectra of: (a) the virgin PET fabric, (b) un-chlorinated finished PET fabric with a percentage add-on of 6.75%, and (c) chlorinated finished PET fabric with 3973 ppm of active chlorine. Inserts are the spectra in the range of 2800 cm⁻¹-3500 cm⁻¹.

FIG. 8 shows EDS spectra of (a) the virgin PET fabric, (b) un-chlorinated finished PET fabric with a percentage add-on of 6.75%, (c) chlorinated finished PET fabric with 3973 ppm of active chlorine; and (d) SEM image (d1) and corresponding elemental mapping of C (d2-C). N (d3-N), and Cl (d4-Cl) of the chlorinated finished PET fabric.

FIG. 9 shows (a) the effects of finishing add-on on air permeability and tearing strength of the finished PET fabrics; (b) tearing strength of the finished PET fabrics after 50 wash cycles.

FIG. 10 shows SEM images of S. epidermidis (a, b), E. coli (c, d), and C. albicans (e, f) biofilms formed on virgin PET (a, c, e) and N-halamine finished PET with 3973 ppm of active chlorine (b, d, f).

FIG. 11 shows fluorescence images of S. epidermidis (a, b), E. coli (c, d), and C. albicans (e, f) biofilms formed on virgin PET (a, c, e) and N-halamine finished PET with 3973 ppm of active chlorine (b, d, f); 1 or 2 after each letter represent live staining channel images (green) or dead staining channel (red) images, respectively.

FIG. 12 shows effects of the finishing add-on of the N-halamine finished PET fabrics on L929 mouse fibroblast viability. Data were normalized to L929 cells in culture media that were not exposed to the extracts (blank control=100% cell viability).

FIG. 13 demonstrates monitorability of the active chlorine content on the finished polyester textiles by color change with test strips containing: a) 0 ppm (virgin polyester fabric), b) 500 ppm, c) 1500 ppm, and d) 4000 ppm of active chlorines. Color darkens as the textile carrying more active chlorine, which will lead to more potent antimicrobial effects.

### DETAILED DESCRIPTION

Research efforts to date have focused on controlling microbial contamination on textiles by introducing antimicrobial functions to the materials through functional finishing, particularly the finishing of natural textiles such as cotton and its blends. Durable finishing for synthetic textiles such as polyester (e.g., poly(ethylene terephthalate), PET), is a long-standing challenge. PET is one of the most important synthetic textiles used in healthcare settings (uniforms, gowns, isolation curtains, etc.) and many other related fields. However, because of its smooth fiber surface, high hydrophobicity, and lack of reactive groups, functional finishing add-ons are normally low, and durability is poor. Currently available technologies include non-aqueous systems such as liquid paraffin, superficial CO₂,or organic solvents to enhance absorption, but the cost and operational difficulties have limited their wider use. See, e.g., Xu, S.; Chen, J.; Wang, B.; Yang, Y. Journal of Cleaner Production 2016, 112, 987-994; Cardozo-Filho, L.; Mazzer, H. R.; Santos, J. C.; Andreaus, J.; Feihrmann, A. C.; Beninca, C.; Cabral, V. F.; Zanoelo, E. F. Text Res J 2014, 84 (12), 1279-1287; Gebert, K. J. Soc. Dyers Colour. 1971, 87 (12), 509-513. For instance, the costs of superficial CO₂ are high, and various organic solvents are difficult to handle or dispose of in general practices. Urea-formaldehyde resins or melamine-formaldehyde resins have been employed as crosslinkers to bind finishing chemicals onto PET (Nousianinen, P.; Mattila-Nurmi, M.-R. J. Appl. Polym. Sci. 1986, 31 (2), 597-620), but the use of such resins causes environmental and health concerns related to formaldehyde release. PET fabrics can be pre-hydrolyzed with alkaline to generate —OH and —COOH groups for post-treatments (see, e.g., Ibrahim, N. A.; Eid, B. M.; Khalil, H. M.; Almetwally, A. A. Appl. Surf. Sci. 2018, 448, 95-103; Ma, K.; Jiang, Z.; Li, L.; Liu, Y.; Ren, X.; Huang, T.-S. Fibers Polym. 2014, 15 (11), 2340-2344; Lin, J.; Winkelmann, C.; Worley, S. D.; Kim, J.; Wei, C.-I.; Cho, U.; Broughton, R. M.; Santiago, J. I.; Williams, J. F. J. Appl. Polym. Sci. 2002, 85 (1), 177-182; Ren, X.; Kocer, H. B.; Kou, L.; Worley, S. D.; Broughton, R. M.; Tzou, Y. M.; Huang, T. S. J. Appl. Polym. Sci. 2008, 109 (5), 2756-2761), but the physical/mechanical properties of the fabrics can be negatively affected, and the add-on is rather low. Also, various monomers can be grafted onto PET fabrics to form graft copolymers (see, e.g., Liu, S.; Sun, G. Polymer 2008, 49 (24), 5225-5232; Ren, X.; Kou, L.; Kocer, H. B.; Worley, S. D.; Broughton, R. M.; Tzou, Y. M.; Huang, T. S. J. Biomed. Mater. Res. Part B Appl. Biomater. 2009, 89B (2), 475-480; Sun, Y.; Sun, G. J. Appl. Polym. Sci.2001, 81 (6), 1517-1525), yet water-soluble initiators generally have low efficacy in generating free radicals on PET, and organic initiators are normally insoluble in water. Moreover, the free-radical grafting process is challenging to perform in large-quantity manufacturing as the initiators gradually decompose in the treatment bath, causing efficacy and safety concerns. Recently, layer-by-layer self-assembly for functional treatment of PET was reported (Carosio, F.; Laufer, G.; Alongi, J.; Camino, G.; Grunlan, J. C. Polym. Degrad. Stab. 2011, 96 (5), 745-750), but the multiple treatment steps limit its application to small-scale, low-speed productions.

The present inventors have discovered a simple and practical aqueous-based continuous finishing approach to introduce durable antimicrobial functions onto fabrics such as PET. In an aspect, a series of water-soluble copolymers containing at least one halamine precursor and at least one functional group to react with epoxy, e.g., poly(methacrylamide-co-acrylic acid) (PMAs) were synthesized, which were combined with a water-soluble epoxy resin, e.g., poly(ethylene glycol) diglycidyl ether (PEGDGE), to form aqueous-based finishing solutions without the presence of any organic solvents. PET fabrics were found to be easily finished by dipping into a finishing solution, padding to reach predetermined wet pickups, drying, and curing, as will be further described in detail herein. Without wishing to be bound by theory, it is believed that during curing, the ring-opening reaction of the epoxide groups (e.g., on PEGDGE) with the water-soluble copolymer and the end —COOH and —OH groups on a PET textile can form crosslinked, durable finishing on the textiles. Through further treatment, the amide groups on the finished textile can be converted to halamine groups (e.g., N—X, wherein X is a halogen, preferably chlorine (Cl)), for example chloramine (N—Cl) groups, forming acyclic N-halamines. N-halamines are well-established durable and rechargeable antimicrobial agents, which provide potent biocidal functions through the covalently bound oxidative halogens (e.g., chlorines) (Kocer, H. B.; Cerkez, I.; Worley, S. D.; Broughton, R. M.; Huang, T. S. ACS Appl. Mater. Interfaces 2011, 3 (8), 2845-2850; Kocer, H. B.; Worley, S. D.; Broughton, R. M.; Huang, T. S. React. Funct. Polym. 2011, 71 (5), 561-568; Sun, X.; Cao, Z.; Porteous, N.; Sun, Y. Acta Biomater. 2012, 8 (4), 1498-1506; Li, L.; Jung, J.; Ma, W.; Wen, J.; Ren, X.; Sun, Y. Materials Science and Engineering: C 2020, 115, 111122; Hui, F.; Debiemme-Chouvy, C. Biomacromolecules 2013, 14 (3), 585-601; Dong, A.; Wang, Y.-J.; Gao, Y.; Gao, T.; Gao, G. Chem. Rev. 2017, 117 (6), 4806-4862). The finished fabrics were characterized for antibacterial, antifungal, and antiviral functions and biofilm-controlling properties. Advantageously, the antimicrobial, antifungal, and antiviral functions of the finished textiles of the present disclosure were durable upon washing, rechargeable with diluted chlorine bleach, and detectable with colorimetric indicators (compounds that can react with chlorine leading to color change) such as potassium iodide, diethyl-p-phenylene diamine, and the like. A significant advance in textile finishing is therefore provided by the present disclosure.

Accordingly, an aspect of the present disclosure is a textile finishing composition. The textile finishing composition comprises a copolymer. The copolymer can have any suitable composition or configuration and can be, for example, a random copolymer, a block copolymer, a graft copolymer, a linear copolymer, a branched copolymer, a star copolymer, and the like or a combination thereof. In an aspect, the copolymer is a linear copolymer. In an aspect, the copolymer is a branched copolymer.

The copolymer comprises repeating units derived from a carboxylic acid-containing monomer. The carboxylic acid containing monomer comprises at least one carboxylic acid group (—COOH) and a polymerizable moiety. For example, the carboxylic acid containing monomer can be of the structure R¹—L¹—COOH, wherein R¹ is a polymerizable moiety, and L¹ is a linking group. The linking group L¹ can be, for example, a single bond (i.e., the polymerizable moiety can be directly attached to the —COOH group), a substituted or unsubstituted C₁₋₁₂ alkylene group, a substituted or unsubstituted C₆₋₂₀ arylene group, a C₂₋₆ alkylene oxide group, or a poly(C₂₋₆ alkylene oxide group). In an aspect, L¹ is a single bond (i.e., the carboxylic acid containing monomer may be of the formula R¹—COOH.

The polymerizable moiety can comprise ethylenic unsaturation, and can preferably be a vinyl group, an acrylate group, a methacrylate group, an acrylamide group, a methacrylamide group, a styrenic group, and the like, or a combination thereof. In an aspect, the polymerizable moiety comprises a methacrylate or an acrylate. In a specific aspect, the polymerizable moiety comprises an acrylate group. In an aspect, the carboxylic acid-containing monomer comprise one carboxylic acid group per monomer. Polycarboxylic acid monomers (i.e., comprising more than one carboxylic acid group) are also contemplated herein.

Exemplary carboxylic acid containing monomers can include, but are not limited to, acrylic acid, methacrylic acid, ethacrylic acid, alpha-chloroacrylic acid, alpha-cyano acrylic acid, beta methyl-acrylic acid (crotonic acid), alpha-phenyl acrylic acid, beta-acryloxy propionic acid, sorbic acid, alpha-chloro sorbic acid, angelic acid, cinnamic acid, p-chloro cinnamic acid, beta-styryl acrylic acid (1-carboxy-4-phenyl butadiene-1,3), itaconic acid, citraconic acid, mesaconic acid, glutaconic acid, aconitic acid, maleic acid, fumaric acid, and tricarboxy ethylene.

In an aspect, the repeating units derived from a carboxylic acid-containing monomer are derived from (meth)acrylic acid, more preferably from acrylic acid.

In addition to the carboxylic acid-containing monomer, the copolymer further comprises repeating units derived from a polymerizable halamine precursor, preferably a polymerizable chloramine precursor. As used herein, a halamine precursor refers to a moiety which, upon activation with a halogen, can provide a derivative of ammonia or an organic amine wherein at least one N—H bond is replaced by a N—X bond, wherein X is a halogen, such as Cl. Exemplary polymerizable halamine precursors can include, but are not limited to, methacrylamide, acrylamide, 3-allyl-5,5-dimethylhydantoin, 3-(4′-vinylbenzyl)-5,5-dimethylhydantoin, 2,2,6,6-tetramethyl-4-piperidyl acrylate, or 1-acryloyl-2,2,5,5-tetramethylimidazolidin-4-one, or a combination thereof. In a specific aspect, the polymerizable halamine precursor comprises methacrylamide.

In an aspect, the copolymer is a copolymer comprising repeating units derived from (meth)acrylic acid and methacrylamide.

The repeating units derived from the carboxylic acid-containing monomer and the repeating units derived from a polymerizable chloramine precursor can be present in a molar ratio of 5:95 to 95:5, or 10:90 to 90:10, or 20:80 to 80:20, or 30:70 to 70:30, or 40:60 to 60:40. In an aspect, the repeating units derived from a polymerizable chloramine precursor can be present in the copolymer in an amount of greater than 50 mole percent, or 55 to 95 mole percent, or 60 to 95 mole percent, or 65 to 95 mole percent, or 70 to 90 mole percent, Conversely, the repeating units derived from the carboxylic acid-containing monomer can be present in an amount of less than or equal to 50 mole percent, or 5 to 45 mole percent, or 5 to 40 mole percent, or 5 to 35 mole percent, or 10 to 30 mole percent.

In an aspect, the copolymer may comprise repeating units other than the repeating units derived from the carboxylic acid-containing monomer and the polymerizable halamine precursor. In an aspect, when additional repeating units are present, they may be limited to an amount of less than 50 mole percent, or less than 40 mole percent, or less than 30 mole percent, or less than 20 mole percent, or less than 10 mole percent, or less than 5 mole percent, or less than 1 mole percent. Stated another way, the repeating units derived from the carboxylic acid-containing monomer and the repeating units derived from the polymerizable halamine precursor can sum to at least 50 mole percent or at least 60 mole percent, or at least 70 mole percent. or at least 80 mole percent, or at least 90 mole percent, or at least 95 mole percent, or at least 99 mole percent of the copolymer. In an aspect, repeating units other than the repeating units derived from the carboxylic acid-containing monomer and the polymerizable halamine precursor may be excluded from the copolymer of the present disclosure.

The copolymer of the present disclosure is preferably water soluble. Accordingly, the copolymer can comprise a number of hydrophilic groups sufficient to dissolve well in water to provide a transparent or translucent monophasic system.

In addition to the copolymer, the textile finishing composition comprises a water-soluble crosslinking agent. The water-soluble crosslinking agent comprises an epoxy group. As used herein, the crosslinking agent being “water soluble” means that the crosslinking agent dissolves well in water at the concentration of use and can provide a transparent or translucent monophasic system in water.

In an aspect, the water-soluble crosslinking agent comprises at least two epoxide groups per molecule. Exemplary water-soluble crosslinking agent comprising epoxy groups can be as described in U.S. Pat. No. 6,846,938, the contents of which is hereby incorporated by reference. For example, the water-soluble crosslinking agent can comprise glycidyl ethers of sorbitol, glycidyl ethers of other sugars or polysaccharides, glycidyl ethers of celluloses, polyglycerol glycidyl ethers, pentaerythritol glycidyl ethers, trimethylolpropane glycidyl ethers, glycerol glycidyl ethers, poly(ethylene glycol) diglycidyl ethers, glycidyl ethers of poly(vinyl alcohols), poly(propylene glycol) diglycidyl ethers, and the like, or a combination thereof.

In an aspect, the water-soluble crosslinking agent can be a polymer having at least two epoxide groups per molecule, for example as chain-end functional groups or as pendant groups along the polymer backbone, or both. The polymer can be linear or branched. In an aspect, the water-soluble crosslinking agent can comprise a poly(ethylene glycol) diglycidyl ether.

In an aspect, the copolymer and the water-soluble crosslinking agent can be present in the composition in amounts effective to provide a molar ratio of epoxy groups to carboxylic acid groups of preferably 1:1 or more, more preferably 1.5:1 or more, even more preferably 1.5:1 to 6:1.

The textile finishing composition further comprises water.

In an aspect, the total weight of the components of the composition (i.e., the copolymer, the water-soluble crosslinking agent, and the water) sum to at least 90 weight percent, based on the total weight of the textile finishing composition. Within this range, the total weight of the components of the composition can sum to at least 95 weight percent, or at least 98 weight percent, or at least 99 weight percent, or at least 99.9 weight percent, each based on the total weight of the textile finishing composition.

The textile finishing composition can optionally comprise one or more additional ingredients to enhance the characteristics of the final finished textile, provided that the presence of the one or more additional ingredients does not adversely affect a desired property of the finished textile (i.e., the antimicrobial, antifungal, or antiviral properties). For example, the one or more additional ingredients can be selected from wetting agents, brighteners, softening agents, stain repellant agents, color enhancing agents, anti-abrasion additives, water repellency agents, UV absorbing agents and fire retarding agents. When present, the one or more additional ingredients can be present in amounts that are generally known to be effective.

The textile finishing composition can be useful in a method of finishing a textile. A method of finishing a textile therefore represents another aspect of the present disclosure. In an aspect, the method comprises applying the textile finishing composition to a textile.

As used herein, the term textile includes fabrics, yarns, and articles comprising fabrics and/or yarns, such as garments, home goods, including, but not limited to, bed and table linens, draperies and curtains, and upholsteries, and the like.

The textile can be natural or synthetic (i.e., comprising natural or synthetic fibers). “Natural fibers” refers to fibers which are obtained from natural sources, for example cellulosic fibers and protein fibers, or which are formed by the regeneration of or processing of natural occurring fibers and/or products. Natural fibers can include fibers formed from cellulose, such as cotton fiber and regenerated cellulose fiber, commonly referred to as rayon, or acetate fiber derived by reacting cellulose with acetic acid and acetic anhydride in the presence of sulfuric acid. The term “natural fibers” are intended to include natural fibers in any form, including individual filaments, and fibers present in yarns, fabrics and other textiles, while “individual natural fibers” is intended to refer to individual natural filaments. “Synthetic fibers” refers to fibers that are not prepared from naturally occurring filaments and include, but are not limited to, fibers formed of synthetic materials such as polyesters, polyamides such as nylons, polyacrylics, and polyurethanes such as spandex. Synthetic fibers can include fibers formed from petroleum products. Textiles comprising blends of natural fibers and synthetic fibers are also mentioned.

In an aspect, the textile is a synthetic textile, preferably comprising a polyester, a polyamide, a polyacrylate, or a combination thereof. In an aspect, the textile comprises a polyester, preferably poly(ethylene terephthalate). In an aspect, the textile is not a glass fabric (e.g., does not include glass fibers).

The textile finishing composition of the present disclosure can be applied to the textile in accordance with any of the conventional techniques that are generally known. In an aspect, the composition can be applied to the textile by saturating the textile with the composition in a trough and squeezing the saturated textile through pressure rollers to achieve a uniform application, also referred to as a padding process. Other application techniques that can be employed include kiss roll application, engraved roll application, printing, foam finishing, vacuum extraction, spray application or any process known in the art. Generally these techniques provide lower wet pick-up than the padding process. The concentration of the components of the composition can be adjusted to provide the desired amount of the composition on the textile.

In an aspect, applying the textile finishing composition can comprise continuously dipping the textile into a finishing bath comprising the textile finishing composition. Following application of the textile finishing composition to the textile, the method further comprises padding the textile.

The method further comprises drying the textile. Drying the textile may employ any suitable conditions to provide the coated textile and can include for example, a temperature of 100° C. or more.

The coated textile can be subjected to curing conditions to facilitate reaction of the crosslinking agent with the carboxylic acid groups of the copolymer. Curing can be, for example, thermal curing and thus can be effected by heating the coated textile for a time and at a temperature sufficient for crosslinking to occur. For example, the coated textile can be heated (cured) at a temperature greater than or equal to 100° C., for example 100 to 220° C., or 110 to 220° C., or 150 to 220° C., in an oven for a period of 0.1 to 15 minutes, for example 0.1 to 5 minutes, or 0.5 to 5 minutes, or 0.5 to 3 minutes, or 1 to 3 minutes. In general, there is an inverse relationship between curing temperature and curing time. Thus, the higher the temperature of curing, the shorter the dwell time in the oven; conversely, the lower the curing temperature, the longer the dwell time in the oven. In an aspect, the curing can be at a temperature of, for example, 140° C. or more, or 160° C. or more.

The cured, coated textile can then be chlorinated to provide the desired finished textile having a halamine-containing coating disposed on at least a portion of a surface of the textile. Halogenation (e.g., chlorination) of the coated textile can be achieved, for example, by contacting the textile with a halogenating (e.g., chlorinating) agent, such as chlorine bleach.

A finished textile produced by the method described herein or from the textile finishing composition described herein is also provided. The finished textile comprises a textile and a halamine-containing coating disposed on at least a portion of a surface of the textile, wherein the halamine-containing coating is derived from the textile finishing composition described previously.

The coating may be present on the finished textile in an amount of 1 to 10 weight percent, based on the total weight of the finished textile. In an aspect, the coating may be present in an amount effective to provide a total halogen content of at least 400 ppm, or at least 500 ppm, or at least 750 ppm, or at least 1,000 ppm. For example, the total halogen content of the finished textile can be 400 to 10,000 ppm, or 400 to 8,000 ppm, or 400 to 6,000 ppm, or 400 to 5,000 ppm, or 1,000 to 5,000 ppm.

In an aspect, the finished textile can have an air permeability of greater than or equal to 800 L/m²/s, for example 800 to 1200 L/m²/s, or 900 to 1200 L/m²/s, or 1000 to 1200 L/m²/s. In an aspect, the air permeability of the finished textile is at least 60% of the air permeability of the same textile not including the coating, or at least 75% of the air permeability of the same textile not including the coating, or at least 80% of the air permeability of the same textile not including the coating.

Advantageously, the particular coating resulting from the textile finishing composition described herein can provide anti-bacterial properties, anti-fungal properties, anti-viral properties, or a combination thereof. For example, the finished textile can provide a total kill of bacteria within five minutes, a total kill of yeast within 20 minutes, and a total kill of bacteriophage within 30 minutes. The time to total kill of the bacterial, fungal, or viral species can depend on the chlorine concentration of the finished textile. For example, a finished textile comprising 500-550 ppm of halogen can provide a total kill of bacteria within five minutes, a total kill of yeast within 20 minutes, and a total kill of bacteriophage within 30 minutes. A finished textile comprising 1500-1550 ppm of halogen can provide a total kill of bacteria within five minutes, a total kill of yeast within 15 minutes, and a total kill of bacteriophage within 15 minutes. These and other properties are further described in the context of the working examples below.

The finished textiles can also provide desirable biofilm-controlling properties. For example, a finished textile according to the present disclosure can provide a 50-100% reduction of adherent bacterial or fungal levels compared to a virgin (i.e., uncoated) textile. These and other properties are further described in the context of the working examples below.

The coated textile can be durable. For example, the coating can retain any of the foregoing properties upon washing. For example, after 10 wash cycles, the finished textile can retain at least 50% of the active halogen content relative to the chlorine content of the finished textile prior to washing.

In an additional advantageous feature, the anti-bacterial function of the finished textile can be monitored by a color-based assay, preferably at the point of use. The anti-bacterial function of the finished textile can be regenerated by treating with halogen-containing agents, for example using sodium hypochlorite bleach, as further described in the working examples below.

Another aspect of the present disclose is a method of determining anti-bacterial properties of a finished textile. In an aspect, the method comprises contacting the finished textile with a compound capable of reacting with the halogen to cause a color change to provide a colorimetric assessment of active halogen content of the finished textile. In an aspect, the compound capable of reacting with the halogen (e.g., chlorine) can comprise potassium iodide, diethyl-p-phenylene diamine, and the like, or a combination thereof. In an aspect, the compound can be disposed on a test strip.

This disclosure is further illustrated by the following examples, which are non-limiting.

### EXAMPLES

Materials and instrumentation used in the following examples are described below.

The PET fabric was from Testfabrics (West Pittston, PA, filament polyester in a double-knit pattern). Acrylic acid (AA), potassium persulfate (KPS), poly(ethylene glycol) diglycidyl ether (PEGDGE, average Mn 500) were provided by Sigma-Aldrich (St. Louis, MO). Methacrylamide (MAAm) and sodium hydroxide (NaOH) were from Acros Organics. Live/Dead Baclight™ bacterial viability kit (L7007) was from Thermo Fisher Scientific. Regular Clorox bleach was used for chlorination. The microorganisms, Staphylococcus epidermidis (S. epidermidis, ATCC 35984), Escherichia coli (E. coli, ATCC 15597), Candida albicans (C. albicans. ATCC 10231), and MS2 virus (ATCC 15597-B1) were obtained from American Type Culture Collection (ATCC, Manassas, VA).

Fourier transform infrared (FT-IR) study was carried out using a Thermo Nicolet iS10 FTIR spectrometer. A JEOL JSM 7401 FE-SEM with EDAX genesis XM2 imaging system was used for SEM and energy dispersive X-ray spectrometry (EDS) analysis. Fluorescence microscopy was performed on an EVOS M5000 imaging system (Thermo Fisher Scientific, USA) using EVOS GFP light cube (excitation/emission: 470/525 nm) and EVOS RFP light cube (excitation/emission: 531/593 nm). Water contact angles were measured using the VCA optima surface analysis system (AST, MA, USA). Air permeability of the fabrics was tested with an air permeability tester (SDL Atlas MO21A) following the ASTM test method D737. The tearing strength of the samples was determined on an electronic Elmendorf tear tester (ProTear) according to the ASTM D1424. The flat abrasion resistance of the fabrics was determined with an abrasion scrub tester (BYK-Gardner) as specified in the ASTM standard method D3384.

### Synthesis of poly(methacrylamide-co-acrylic acid) (PMA)

A series of PMAs with various MAAm/AA molar ratios (9/1, 8/2, 7/3, and the resultant polymers were denoted as PMA9-1, PMA8-2, and PMA7-3, respectively) were synthesized in aqueous solutions through free radical copolymerization using KPS as the initiator following a previously reported procedure (Li, L.; Jung, J.; Ma, W.; Wen, J.; Ren, X.; Sun, Y. Enhanced antimicrobial and antifungal property of two-dimensional fibrous material assembled by N-halamine polymeric electrolytes. Materials Science and Engineering: C 2020, 115, 111122). Briefly, MAAm and AA at various molar ratios were dissolved in 200 ml deionized water with the total monomer content kept at 0.2 mole. The initiator KPS (1% of the monomer content) was added into the solution under N₂ atmosphere. The copolymerization was conducted at 65° C. for 2 h under stirring to produce the PMA aqueous solutions. The solution was dialyzed with deionized water, and freeze-dried to obtain dry PMA polymers. Molecular weights of the resulting PMA samples were determined by photon correlation spectroscopy (PCS) analysis on a Delsa Nano HC analyzer. Nitrogen contents were tested by elemental analysis to calculate the compositions of the copolymers.

### Preparation of N-halamine finished PET fabrics

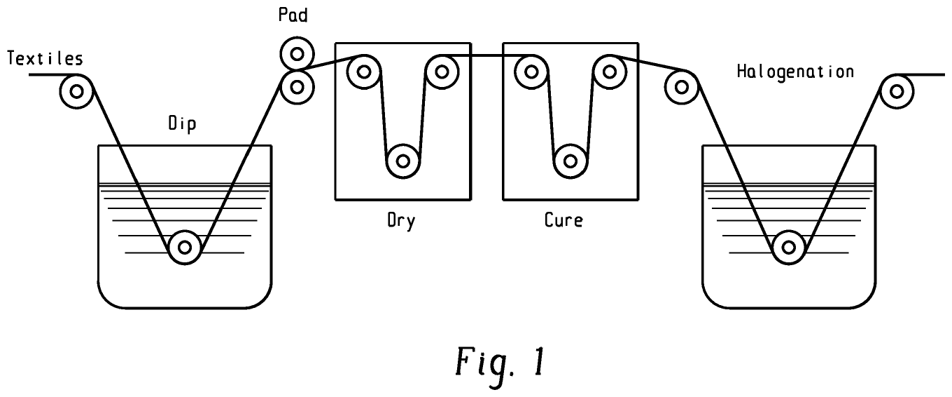

PMA was finished onto PET fabrics by crosslinking with PEGDGE through a dip-pad-dry-cure process, shown in FIG. 1. Briefly, a series of aqueous mixtures of PMA and PEGDGE were prepared by varying copolymer contents and mixing ratios. PET fabrics were dipped into the aqueous solution for 10 min, followed by padding through a lab wringer to obtain a 100% weight pick-up. The fabrics were dried at 100° C. for 10 min and then cured at various temperatures (100, 120, 140, 160, 180, and 200° C.) for 5 min. Afterward, the samples were washed with deionized water in the presence of the American Association of Textile Chemists and Colorists (AATCC) standard reference detergent 1993, rinsed, and dried at 60° C. in an oven to reach constant weights. The percentage add-on of the finishes on the textiles was calculated following the equation below:

$$Add ‐ on \% = ( \frac{{W}_{2} - {W}_{1}}{{W}_{1}} ) \times 100$$

where W₁ and W₂ were the weights of the original and the finished textiles, respectively.

The amide groups of the MAAm moieties on the finished fabrics were converted to N-halamines by chlorinating in a 10% Clorox™ bleach solution (bath ratio was 1/30, pH=7) at ambient temperature for 60 min. Thereafter, the fabrics were washed thoroughly, followed by drying at 45° C. to remove residual chlorines on the surfaces. The contents of active chlorine on the N-halamine PET were tested by iodometric/thiosulfate titration, following a previously reported procedure. See, e.g., Luo, J.; Sun, Y. Acyclic N-halamine-based fibrous materials: Preparation, characterization, and biocidal functions. J. Polym. Sci., Part A: Polym. Chem. 2006, 44 (11), 3588-3600.

### Durability and Rechargeability

The N-halamine finished PET fabrics were stored at ambient environments (around 20° C. and 60% relative humidity). Periodically, the level of active chlorine was tested with titration, as described above. Wash durability of the N-halamines on the PET was determined under home laundering (hand wash) conditions following AATCC 124-2014 using the AATCC standard reference detergent 1993 at 41° C. After 10, 20, 30, and 50 wash cycles, residual chlorine contents on the fabrics were determined. Besides, after various cycles, the washed fabrics were re-bleached with the same conditions as described above, and the chlorine contents on the resulting samples were tested to evaluate the rechargeability of the N-halamines on the finished PET.

### Antimicrobial Activities

The antimicrobial tests were performed following the AATCC test method 100-2019 with slight modifications by challenging the N-halamine fabrics against S. epidermidis (Gram-positive bacteria), E. coli (Gram-negative bacteria), C. albicans (fungi), and MS2 virus, respectively. In the tests against the bacteria and fungi, 50 μL 10⁸-10⁹ CFU/mL of S. epidermidis, E. coli, or C. albicans was transferred to the center of a fabric swatch (1×1 cm) in a sterile jar. At different time points (5-60 min), each swatch was immersed into 4 mL of sterile 0.01 N sodium thiosulfate to stop the antimicrobial tests. The container was vortexed for 1 min followed by sonication for 5 min to detach the organisms from the swatch into the solution. With serial dilution, each diluent was plated onto nutrient agar plates in duplicate for incubation. Microbial colony forming units (CFUs) were recorded after culturing at 37° C. (for bacteria) or 25° C. (for the yeast) for 1 day.

In the antiviral tests, PET swatches (2.5×5.0 cm, wrapped around an aluminum coupon and attached using 2 metal bobby pins) were spotted individually with 10 μL stock MS2 virus (final concentration of 1.46×10¹³ plaque-forming units per milliliter, PFU/mL) and allowed to stand for different periods (10-60 min). Each swatch was submerged in sterile DE neutralization broth to stop the antiviral activity and the mixture was shaken on a wrist-action shaker for 10 min. The obtained suspension was serially diluted and 100 μL of each dilution was mixed with 100 μL of a 6-h culture of the host E. coli, and then 10 mL of molten 0.5x tryptic soy agar were added. The entire mixture was poured into a petri dish and gently swirled to cover the entire plate. After solidification, the plates were incubated for 24 h at 37° C. for PFU determination. The untreated PET fabrics (negative control) was tested with the same procedures. Each experiment was repeated 3 times.

### Anti-Biofilm Functions

A series of N-halamine finished PET fabric swatches (1×1 cm) were submerged individually in 2.0 mL of S. epidermidis. E. coli, or C. albicans PBS suspensions at densities of 10⁸-10⁹ CFU/mL. After 1 h of adhesion at 37° C. under gentle shaking, each swatch was washed gently with 100 mL PBS three times and placed in 5 mL broth solutions at 37° C. for 48 h to form biofilms. The swatches were rinsed gently with PBS (100 mL×3 times) to detach the non-adherent organisms. Some of the swatches were utilized to evaluate the level of formed biofilms by CFU determination of recoverable adhering microorganisms, as described previously. Some of the swatches were stained with the Live/Dead Baclight™ bacterial viability kit and visualized for fluorescence activities. The remaining swatches were placed in 2.5% of formaldehyde/glutaraldehyde solution at 4° C. overnight. After three rinses in sterile PBS, the swatches were dehydrated through an alcohol gradient and observed with the SEM to check for the presence of biofilms. The virgin PET fabrics were tested with the same method as controls.

### Cytotoxicity Evaluation

The cytotoxicity of various N-halamine finished PET fabrics was evaluated using the XTT assays on L929 mouse fibroblasts (ATCC CCL-1) according to the method specified by ISO 10993-5:2009. In brief, various N-halamine finished PET fabrics were individually extracted (at a surface/volume ratio of 6 cm²/mL, according to ISO 10993-12) in cell culture medium with shaking for 1 and 3 days at 37° C., respectively. The fibroblast cells were cultured at 37° C. in 5% CO₂ and 95% air. At confluence, the fibroblasts were trypsinized. After centrifugation, the cells were suspended in culture medium and the final cell density was 1×10⁵ cells/mL. An aliquot of 0.1 mL of the cell was placed into each well of a 96-well plate for 24 h of pre-culturing. The culture media were replaced with the extracts from the finished PET fabrics. After incubation for 24 hours, XTT reagents were added (50 μL to each well) and the cells were incubated for 3 h at 37° C. in the dark. The absorbance of the solution in each well was measured at 475 nm with a reference wavelength of 660 nm using a plate reader (Infinity M200 Pro, Tecan). The fibroblasts incubated in the original culture medium were evaluated with the same conditions as negative controls, and the cells in culture medium supplemented with 1% Triton X-100 were used as positive controls (n=4).

### Statistical Analyses

The data were representative of the findings from at least three parallel experiments and reported as mean±standard derivation. Statistical comparisons between two groups were performed using Student's t-test at 95% of confidence level.

### Preparation and Characterization of N-halamine Finished PET Fabrics

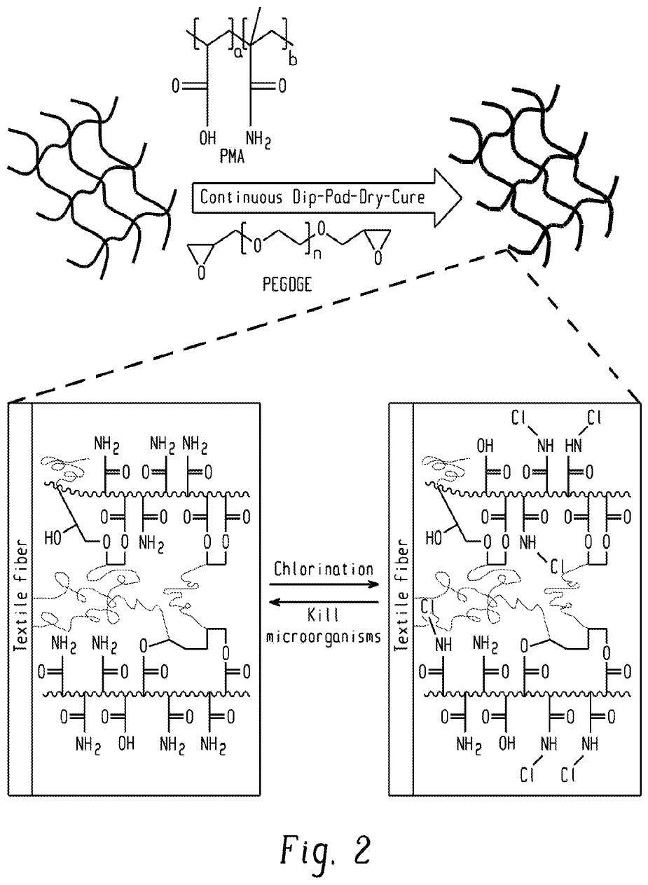

While durable finishing of natural fibers such as cotton is relatively easy to perform, finishing of synthetic fibers, particularly PET, is a long-standing technical challenge because of its high hydrophobicity and lack of reactive groups on the smooth fiber surface. This study developed a two-component treatment system containing PMA and PEGDGE, to introduce durable antimicrobial and biofilm-controlling functions into PET using a simple and practical aqueous-based pad-dry-cure process. In this design, the methacrylamide (MAAm) moieties in the PMA are precursors of N-halamines, which could be chlorinated to generate acyclic N-halamines to achieve antimicrobial functions. Since polymethacrylamide (PMAAm) has limited water solubility and low reactivity (weak nucleophile) toward epoxide, MAAm was copolymerized with acrylic acid (AA) to produce PMA. The functions of the AA moieties in the PMA are twofold: (1) rendering the copolymers water-soluble, and (2) reacting with the epoxide groups in PEGDGE as curing agents. It was anticipated that after padding the PMA and PEGDGE onto PET, during curing, the carboxylic acid groups in the PMA can serve as nucleophiles for the ring-opening reactions of the epoxide groups in PEGDGE, forming ester linkage between the PMA chains and PEGDGE. Besides, opening every epoxide ring leads to the formation of a secondary hydroxyl group, which can also react with epoxide groups from other PEGDGE chains. Further, the end groups (—COOH and —OH) in PET can react with epoxide groups on PEGDGE or the PEGDGE/PMA conjugates. Thus, PMA moieties are finished to the fabrics through these crosslinking reactions. After treatment with bleach, the amide groups in the finishes are converted to N-halamines for antimicrobial applications. The simplified pathway is shown in FIG. 2.

A series of PMAs were synthesized by varying the MAAm and AA contents, and as low as 10% molar of AA in the monomer mixture rendered the copolymers completely water-soluble. To broaden the selection options and investigate the effects of copolymer compositions on finishing, three PMA copolymers, PMA9-1, PMA8-2, and PMA7-3, were synthesized and evaluated for functional finishing. Their characteristics are summarized in Table 1.

TABLE 1

| | MAAm in the | MAAm | |
|---|---|---|---|
| | monomer | in the | Molecular |
| | mixtures | PMA | weight |
| Copolymer | (mol %) | (mol %) | (kDa) |
| PMA9-1 | 90% | 88% | 49.26 |
| PMA8-2 | 80% | 78% | 45.63 |
| PMA7-3 | 70% | 70% | 37.61 |

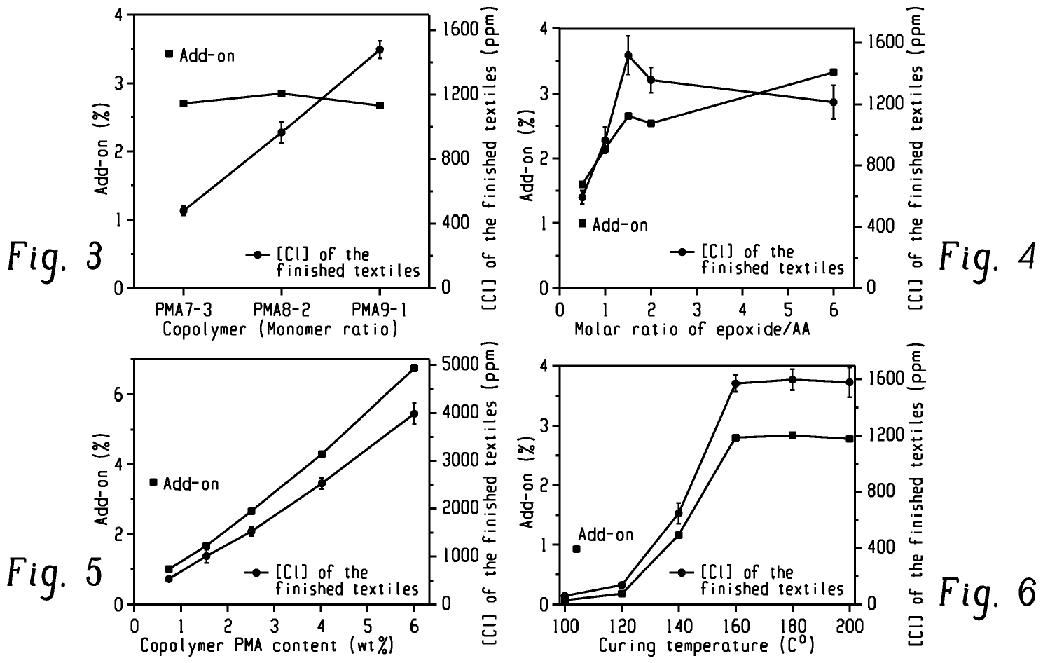

The influences of finishing conditions on the resultant percentage add-on and active chlorine contents were investigated. FIG. 3 shows the effects of the PMA copolymer compositions. Keeping other conditions constant, increasing the MAAm molar content in the PMA copolymers had little effects on percentage add-on, but significantly increased the active chlorine contents on the finished textiles. In the design of the present disclosure, the AA moiety was used to react with the epoxide groups in PEGDGE to link the PMA copolymer onto PET. When sufficient amounts of AA were presented, even higher AA content did not lead to higher add-on. On the other hand, the active chlorine on the N-halamines were produced from the amide groups on MAAm, and higher MAAm content on the finished textiles would result in higher N-halamine concentration.

The molar ratio of the epoxide groups in PEGDGE and AA moieties in PMA had significant effects on the finishing reaction. A representative example is shown in FIG. 4. The percentage add-on of the finishes increased rapidly by increasing the epoxide/AA molar ratio up to 1.5/1. After that, the increasing trend became less obvious. It is interesting to note that without PMA when 4.4% of PEGDGE was used alone to finish PET, the resulting percentage add-on was much lower at 1.25%. These results strongly suggested that the finishing was mainly achieved by the reaction of the epoxide groups in PEGDGE and carboxylic acid groups of AA in the PMA. The active chlorine content of the finished PET showed a similar trend with the epoxide to AA molar ratio increasing up to 1.5/1 but slightly decreased with further increasing the molar ratio to 6/1. A higher epoxide to AA ratio would result in higher crosslinking density, which could block part of the amide groups from chlorination during the bleach treatment, resulting in lower active chlorine contents.

The effects of the copolymer PMA content on the finishing are presented in FIG. 5. Maintaining other conditions constant, both the percentage add-on and the active chlorine content of the finished textiles was found to increase with increasing PMA content in the finishing bath, providing a reliable engineering strategy to design and control the chlorine content, and thus, antimicrobial potency, of the resulting fabrics for various applications.

The ring-opening reaction of epoxide with a carboxylic acid is a very slow process. At ambient temperature, the aqueous finishing solution containing PMA and PEGDGE was stable for longer than 1 week without any precipitations, a desirable feature for real applications. Curing at a high temperature significantly promoted crosslinking reactions. As shown in FIG. 6, the percentage add-on and chlorine content slowly increased with the increase of curing temperature of 100° C. to 120° C., then rapidly increased until 160° C. Thereafter, further increasing curing temperature to 200° C. had little effect on the finishing reactions.

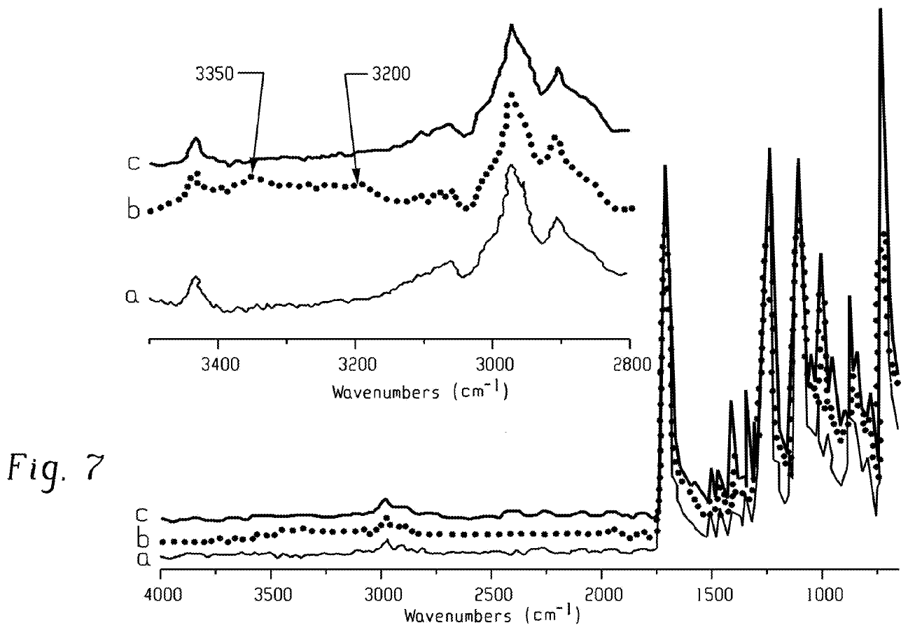

The finishing process was studied with FT-IR (FIG. 7). Due to the strong signals of the PET polymer, the spectra of the virgin PET, un-chlorinated finished PET, and chlorinated finished PET showed similar bands. Nevertheless, clear differences could be observed in the region of 3100 cm⁻¹-3500 cm⁻¹ (FIG. 7 insert). The virgin PET had a band at 3430 cm⁻¹ (FIG. 7, trace a), which was caused by the end —OH groups. After finishing with PMA and PEGDGE, two new bands around 3350 cm⁻¹ and 3200 cm⁻¹ appeared (FIG. 7, trace b), attributable to the stretching vibration of —NH₂ on MAAm, suggesting that PMA was successfully finished onto the fabrics. Upon chlorine bleach treatment, these two bands disappeared, leaving a weak broad signal ranging at 3350-3200 cm⁻¹ (FIG. 7, trace c), indicating that at least a portion of the —CONH₂ on the PET were transformed into acyclic N-halamines by chlorination.

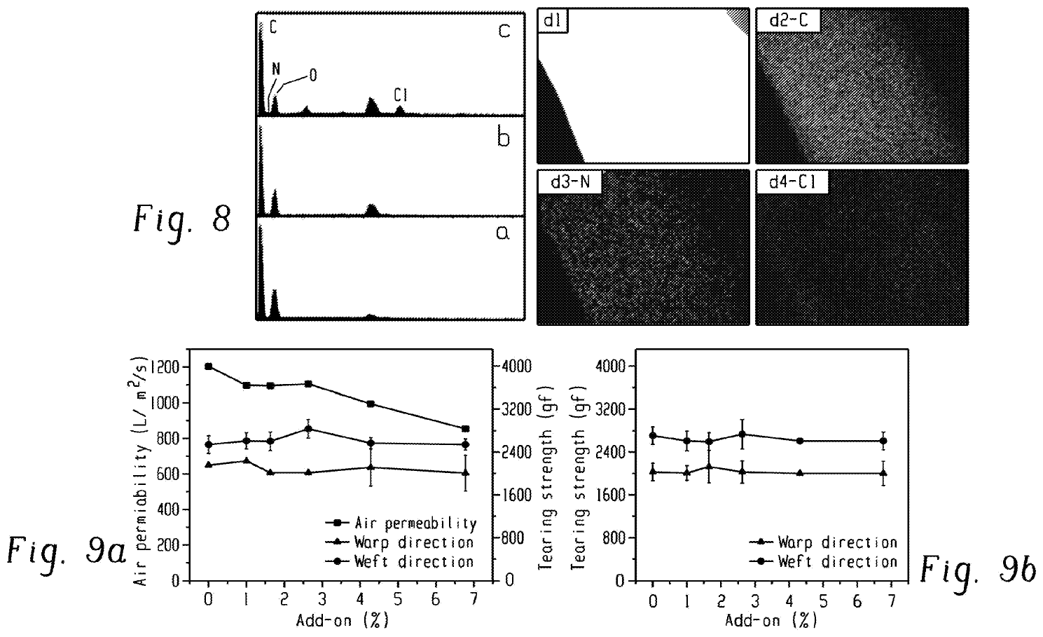

The finishing process was further confirmed with EDS analysis (FIG. 8). The virgin PET displays only C (0.277 keV) and O (0.277 keV) elements (FIG. 8a). The un-chlorinated finished PET showed a weak signal of nitrogen at 0.392 keV (FIG. 8b), confirming that PMA was finished onto the fabrics. Upon chlorine bleach treatment, Cl (2.621 keV) element appeared in the chlorinated finished PET (FIG. 8c), suggesting the conversion of the —CONH₂ groups to acyclic N-halamines. In elemental mapping (FIG. 8d), homogeneous distribution of C (d2-C), N (d3-N), and Cl (d4-Cl) was observed, suggesting that the finishes were evenly distributed on the PET fibers.

### Physical and Mechanical Properties of N-Halamine Finished PET Fabrics

The water contact angle of the virgin PET fabric angle was 139.4±3.3○, suggesting a very hydrophobic surface. All the finished PET fabrics showed a highly hydrophilic surface. In the measurement of water contact angle, the water droplets quickly spread on the surface and absorbed by the finished PET fabric in seconds. Thus, no water contact angle could be measured. On the other hand, if the fabric was finished with PEGDGE alone at a percentage add-on of 1.25%, the PET fabric had a water contact angle of 127.5±4.1○. Thus, the highly hydrophilic surface of the PET finished with PMA and PEGDGE must be caused by the AA moieties in PMA.

In the evaluation of comfort performance, the air permeability of the finished PET only slightly decreased at lower than 3 wt % of percentage add-on (FIG. 9). With further increase of percentage add-on to 6.75 wt %, the air permeability gradually decreased, because of the cross-linked polymers on the fabric. On the other hand, the finishes had little effect on tearing strength (FIG. 9). Without wishing to be bound by theory, the finishes are present on the fiber surface (as shown in FIG. 8), and thus are believed to have little effect on bulk structures and mechanical properties.

An attractive feature of the finished PET was the enhanced abrasion resistance. The virgin PET survived 46 strokes of scrubs. The presence of the finishes significantly increased resistance to scrubs. With a percentage add-on of 6.75%, the fabric could be scrubbed as high as 80 times before failure. This improvement in abrasion resistance could be due to that (1) the finishes acted as a physical protective barrier against abrasion of the textiles, and/or (2) the hydrophilic finishes absorbed moisture from the surrounding environment to form a hygroscopic fabric surface, which could serve as lubricants to reduce friction between the scrub tester and the PET fabric.

The N-halamine finished PET showed excellent storage stability. Under ambient conditions (around 20° C. and 60% relative humidity) the level of active chlorine on the fabrics was not changed after three months of storage.

In a laundering test, washing was observed to gradually reduce active chlorine content, as shown in Table 2. However, even after 50 washes, the chlorinated fabrics still contained residual chlorines. Further, after 50 washing cycles, the fabrics were re-chlorinated, and around 90% of the original chlorine was regenerated. These data strongly suggested that the decrease in chlorine content in washing was mainly because of the disassociation of the N—Cl structure, not the loss of the PMA/PEGDGE finishes, confirming the durable and rechargeable feature of the active chlorine on the finished PET fabrics. Further, the tearing strength of the N-halamine finished PET did not change after 50 washing cycles (FIG. 9b), making the finished fabrics even more attractive for various applications.

TABLE 2

| | Active chlorine content | |
|---|---|---|
| | (ppm) of the representative | |
| Wash cycles | finished polyester textiles | |
| 0 | 1525 | 3973 |
| 10 | 1207 | 2362 |
| 20 | 826 | 1620 |
| 30 | 552 | 1074 |
| 50 | 277 | 584 |
| Re-chlorination | 1380 | 3505 |
| after 50 washing | | |
| cycles | | |

### Antibacterial, Antifungal, and Antiviral Functions

While the virgin PET and the PET finished with PEGDGE alone (percentage add-on of 1.25%) did not show any biocidal activities, the N-halamine finished PET demonstrated powerful biocidal properties against bacteria, yeast, and viruses. As shown in Table 3, even with a low chlorine content of 531 ppm, the N-halamine PET provided a total kill of the bacteria (10⁸-10⁹ CFU/mL) within 5 min, the yeast (C. albicans, 10⁸-10⁹ CFU/mL) in 20 min, and the bacteriophage MS2 (1.46×10¹³ PFU/mL) in 30 min, respectively. Higher chlorine contents led to more potent biocidal effects. For example, with 1525 ppm of active chlorine on the finished PET, it took only 15 min for the total inactivation of the fungal and viral species. The exceptionally fast biocidal activity could be related to the hydrophilic surfaces of the finished textiles (as revealed by the water contact angle tests), which could promote the contact between the N-halamine moieties on the finished surfaces and the microorganisms.

TABLE 3

| Finished textiles | | | | | |
|---|---|---|---|---|---|
| | Chlorine | | | | |
| | content | Minimum contact time for a total kill (min) | | | |
| Add-on (%) | (ppm) | S. epidermidis | E. coli | C. albicans | MS2 virus |
| 1.00 | 531 | 5 | 5 | 20 | >30 |
| 1.69 | 1006 | 5 | 5 | 15 | >30 |
| 2.64 | 1525 | 5 | 5 | 15 | 15 |
| 4.26 | 2507 | 5 | 5 | 15 | 15 |
| 6.75 | 3973 | 5 | 5 | 15 | 15 |

### Anti-Biofilm Functions

The biofilm-controlling effects of the fabrics are shown in Table 4. The bacterial and fungal species readily colonized the virgin PET fabrics with an adherent level of 10⁷-10⁸ CFU/cm². PET fabrics finished with PEGDGE alone (percentage add-on of 1.25%) showed certain anti-biofilm function and provided 40%-80% reduction of the adherent bacterial or fungal levels compared with the virgin PET controls. It has been reported that polyethylene glycol coatings on solid surfaces have anti-fouling effects because of the hydration of the polymers chains, and the findings here agreed well with these early results. The N-halamine finished PET showed much higher anti-biofilm functions against both the bacteria and fungi. Higher active chlorine content led to higher efficacy: with more than 1525 ppm and 2507 ppm of chlorine, no bacterial cells and fungal cells were recovered from the fabrics, respectively. These results confirmed that the biofilm-controlling functions were provided by the active chlorines on the finished PET.

TABLE 4

| Virgin and | | | | |
|---|---|---|---|---|
| finished textiles | | Recoverable adherent microorganisms in the biofilms | | |
| | Chlorine content | formed on the textile surfaces (CFU/cm²) | | |
| Add-on (%) | (ppm) | S. epidermidis | E. coli | C. albicans |
| 0 | 0 | (1.13 ± 0.27) × 10⁷ | (1.12 ± 0.45) × 10⁸ | (2.66 ± 0.27) × 10⁷ |
| 1.25 | 0* | (2.15 ± 0.47) × 10⁶ | (6.69 ± 2.70) × 10⁷ | (5.80 ± 2.33) × 10⁶ |
| 1.00 | 531 | (3.12 ± 2.49) × 10⁶ | (5.42 ± 0.10) × 10⁷ | (6.73 ± 0.72) × 10⁶ |
| 1.69 | 1006 | (1.94 ± 1.77) × 10⁵ | (2.82 ± 1.60) × 10⁶ | (6.04 ± 0.97) × 10⁵ |
| 2.64 | 1525 | 0 | 0 | (1.61 ± 0.34) × 10⁴ |
| 4.26 | 2507 | 0 | 0 | 0 |
| 6.75 | 3973 | 0 | 0 | 0 |

*PET fabrics finished with PEGDGE alone

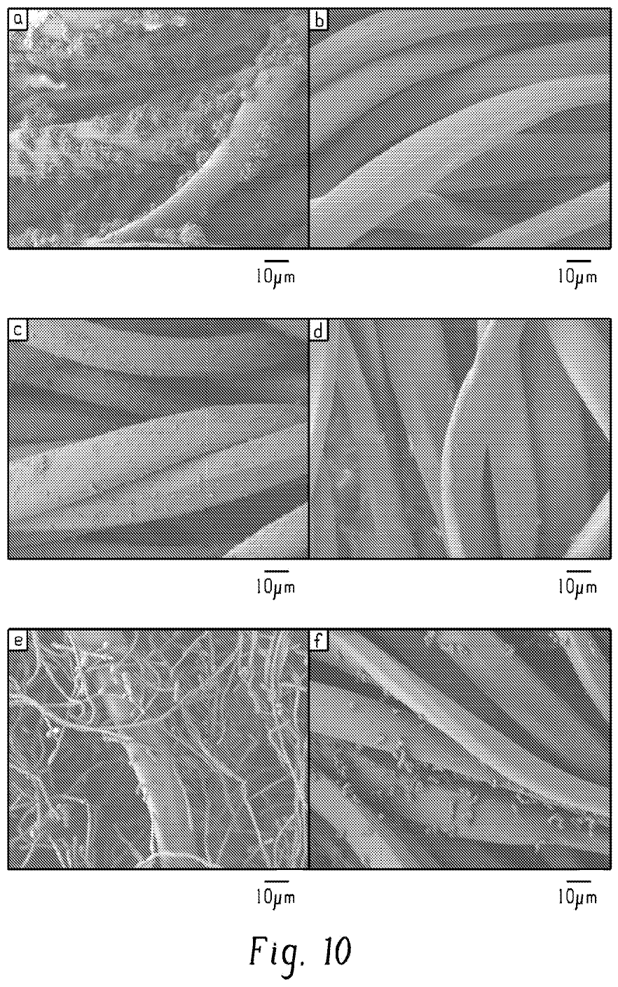

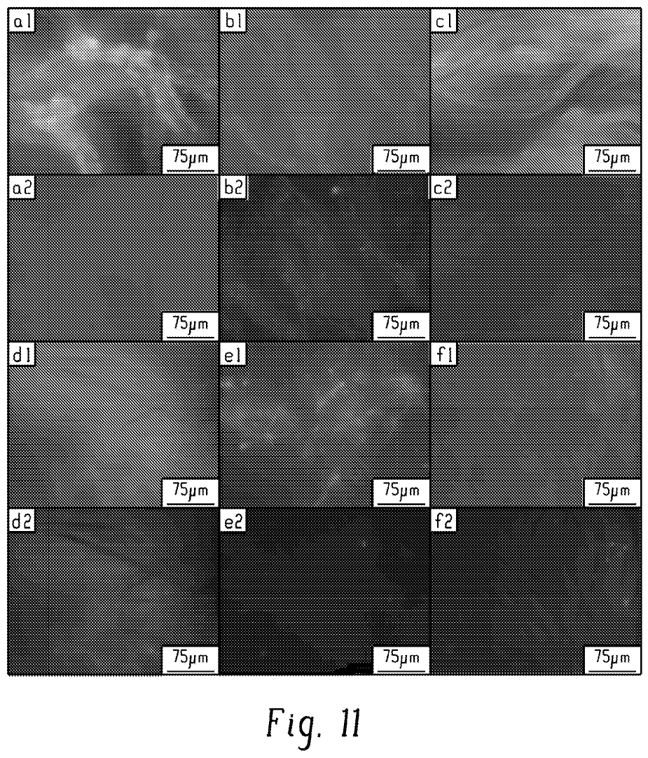

SEM studies were used to further study the anti-biofilm effects against bacteria and fungi. FIG. 10 shows the typical SEM images of the virgin PET and N-halamine finished PET containing 3973 ppm of active chlorine. After incubation for two days, the virgin PET surface had a high amount of layered adherent bacteria clusters (FIG. 10a, c) or C. albicans filamentous cells (FIG. 10e), confirming the formation of bacterial and fungal biofilms. However, much fewer bacterial cells or fungal cells with abnormal shapes were observed on the N-halamine finished PET (FIG. 10b, d, f), further suggesting the potent biofilm-controlling effects of the N-halamines on the finished fabrics.

The anti-biofilm activities were studied by fluorescence microscopy after staining with the Live/Dead Backlight bacterial viability kit, which contains fluorescent nucleic acid dye mixtures of SYTO 9 to stain live cells fluorescent green and propidium iodide to stain dead cells fluorescent red. Similar to the SEM results, a high amount of layered adherent bacteria clusters (FIG. 11a, c) or fungal filamentous cells (FIG. 11e), mostly stained green, presented on the virgin PET surface, suggesting that bacterial and fungal cells in these biofilm structures as seen in the SEM images were most alive. In contrast, only a few distinct dead bacterial or fungal cells in red spots were recognized on the N-halamine finished PET (FIG. 11b, d, f), confirming the potent anti-biofilm efficacy of the N-halamines on the finished fabrics.

### Cytotoxicity Evaluation

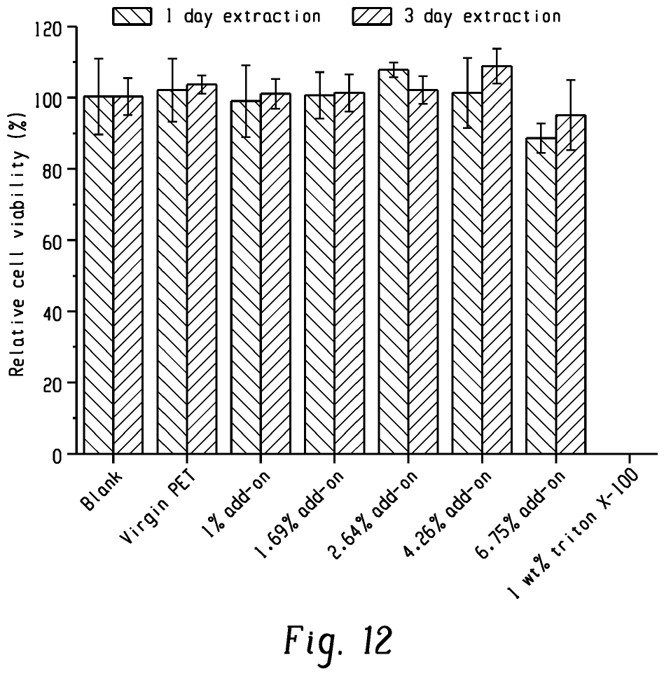

XTT assays were used to evaluate the potential cytotoxic effects of the N-halamine finished PET fabrics on L929 mouse fibroblasts (ATCC CCL-1) as specified by ISO 10993-5:2009. Extracts in culture media from the N-halamine finished PET fabrics were added to L929 cell cultures. Compared to blank media, L929 cell viability was not significantly affected by any of the extracts (FIG. 12), suggesting excellent cytocompatibility of the N-halamine finished PET fabrics.

### Monitorability of the Chlorine Content and thus Antimicrobial Function by Color Change

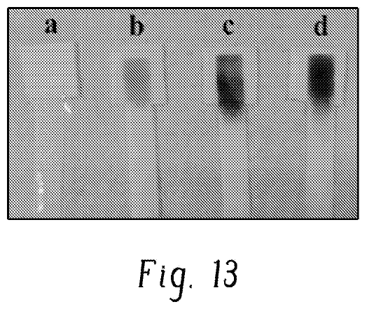

This example shows how to monitor the chlorine content and thus predict the antimicrobial potency by color change: A series of textile swatches (1×1 cm) containing different amount of the finishes with different amount of active chlorines were wetted with 150 ul of water, and a potassium iodide/starch paper strip was put on top of each swatch. After 2 min of contact, the images are shown in FIG. 13.

In conclusion, MAAm was copolymerized with AA in an aqueous solution to produce water-soluble acyclic N-halamine precursors, PMAs, which were finished onto PET fabrics by curing with a PEG-based water-soluble epoxy resin, PEGDGE, through a simple continuous dip-pad-dry-cure process. The finishing bath had a long pot life of up to one week at ambient temperature. Effects of finishing conditions, including the molar compositions of the PMA, the ratios between PMA and PEGDGE, the PMA contents in the finishing bath, and curing temperature, on the finishing were investigated in detail to determine the optimal treatment parameters. The presence of the PMA-based finishes on the PET fabrics was confirmed with FT-IR studies, EDS evaluation, and contact angle measurements. The finishing was durable upon repeated laundering, and the active chlorines were rechargeable by a simple bleach treatment. The finishes hardly affected air permeability and tear strength, but significantly increased abrasion resistance. Further, the N-halamine finished PET fabrics provided potent and fast antibacterial, antifungal, and antiviral efficacies, and inhibited the formation of bacterial or fungal biofilms. Accordingly, a significant improvement is provided by the present disclosure.

This disclosure further encompasses the following aspects.
Aspect 1: A textile finishing composition comprising: a copolymer comprising repeating units derived from a carboxylic acid-containing monomer; and repeating units derived from a polymerizable halamine precursor; a water-soluble crosslinking agent comprising an epoxy group; and water.
Aspect 2: The textile finishing composition of aspect 1, wherein the repeating units derived from a carboxylic acid-containing monomer are derived from (meth)acrylic acid.
Aspect 3: The textile finishing composition of aspect 1 or 2, wherein the polymerizable halamine precursor comprises methacrylamide, acrylamide, 3-allyl-5,5-dimethylhydantoin, 3-(4′-vinylbenzyl)-5,5-dimethylhydantoin, 2,2,6,6-tetramethyl-4-piperidyl acrylate, or 1-acryloyl-2,2,5,5-tetramethylimidazolidin-4-one, or a combination thereof.
Aspect 4: The textile finishing composition of any of aspects 1 to 3, wherein the polymerizable halamine precursor comprises methacrylamide.
Aspect 5: The textile finishing composition of any of aspects 1 to 4, wherein the water-soluble crosslinking agent comprises at least two epoxide groups per molecule.
Aspect 6: The textile finishing composition of any of aspects 1 to 5, wherein the water-soluble crosslinking agent comprises poly(ethylene glycol) diglycidyl ether.
Aspect 7: The textile finishing composition of any of aspects 1 to 6, wherein a molar ratio of moles of epoxy groups to moles of carboxylic acid groups is 1:1 or more, more preferably 1.5:1 or more, even more preferably 1.5:1 to 6:1.
Aspect 8: The textile finishing composition of any of aspects 1 to 7, wherein a weight of the copolymer, the water-soluble crosslinking agent, and the water sum to at least 90 weight percent, or preferably at least 95 weight percent, or preferably at least 98 weight percent, or preferably at least 99 weight percent, or preferably at least 99.9 weight percent, based on the total weight of the textile finishing composition.
Aspect 9: A finished textile comprising: a halamine-containing coating disposed on at least a portion of a surface of a textile, wherein the halamine-containing coating is derived from the textile finishing composition of any of aspects 1 to 8.
Aspect 10: The finished textile of aspect 9, wherein the textile is a natural textile or a synthetic textile.
Aspect 11: The finished textile of aspect 9 or 10, wherein the textile comprises a polyester, a polyamide, a polyacrylate, or a combination thereof, preferably a poly(ethylene terephthalate).
Aspect 12: The finished textile of any of aspects 9 to 11, wherein the finished textile is prepared by a continuous dip-pad-dry-cure-halogenation process.
Aspect 13: The finished textile of any of aspects 9 to 12, wherein the finished textile is anti-bacterial, anti-fungal, anti-viral, or a combination thereof.
Aspect 14: The finished textile of any of aspects 9 to 13, wherein an anti-microbial function of the finished textile can be monitored by a color-based assay, preferably at the point of use.
Aspect 15: The finished textile of any of aspects 9 to 14, wherein the anti-microbial function of the finished textile is durable upon washing.
Aspect 16: The finished textile of any of aspects 9 to 15, wherein the anti-microbial function of the finished textile can be regenerated by treating with halogen-containing agents, preferably sodium hypochlorite bleach.
Aspect 17: A method of finishing a textile, the method comprising: applying the textile finishing composition of any of aspects 1 to 8 to the textile; padding the textile; drying the textile, preferably at a temperature of 100° C. or more to provide a coated textile; curing the coated textile under conditions effective to react the crosslinking agent with the carboxylic acid groups of the copolymer, preferably at a temperature of 140° C. or more; and halogenating the coated textile to provide a finished textile having a halamine-containing coating disposed on at least a portion of a surface of the textile.
Aspect 18: The method of aspect 17, wherein applying the textile finishing composition comprises continuously dipping the textile into a finishing bath comprising the textile finishing composition.
Aspect 19: A method of determining anti-microbial properties of a finished textile, the method comprising: contacting the finished textile of any of aspects 9 to 16 with a compound capable of reacting with a halogen to cause a color change to provide a colorimetric assessment of active halogen content of the finished textile, preferably wherein the compound comprises potassium iodide, diethyl-p-phenylene diamine, and the like, preferably wherein the compound is disposed on a test strip.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles. All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects. Unless specified to the contrary herein, all test standards are the most recent standard in effect as of the filing date of this application, or, if priority is claimed, the filing date of the earliest priority application in which the test standard appears. Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference. Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl—O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Aryl” means an aromatic hydrocarbon group containing the specified number of carbon atoms, such as phenyl, tropone, indanyl, or naphthyl. “Arylene” means a divalent aryl group. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A textile finishing composition comprising:
a copolymer comprising
repeating units derived from a carboxylic acid-containing monomer; and
repeating units derived from a polymerizable halamine precursor;
a water-soluble crosslinking agent comprising an epoxy group; and water.

2. The textile finishing composition of claim 1, wherein the repeating units derived from a carboxylic acid-containing monomer are derived from (meth)acrylic acid.

3. The textile finishing composition of claim 1, wherein the polymerizable halamine precursor comprises methacrylamide, acrylamide, 3-allyl-5,5-dimethylhydantoin, 3-(4′-vinylbenzyl)-5,5-dimethylhydantoin, 2,2,6,6-tetramethyl-4-piperidyl acrylate, or 1-acryloyl-2,2,5,5-tetramethylimidazolidin-4-one, or a combination thereof.

4. The textile finishing composition of claim 1, wherein the polymerizable halamine precursor comprises methacrylamide.

5. The textile finishing composition of claim 1, wherein the water-soluble crosslinking agent comprises at least two epoxide groups per molecule.

6. The textile finishing composition of claim 1, wherein the water-soluble crosslinking agent comprises poly(ethylene glycol) diglycidyl ether.

7. The textile finishing composition of claim 1, wherein a molar ratio of moles of epoxy groups to moles of carboxylic acid groups is 1:1 or more.

8. The textile finishing composition of claim 1,
wherein a weight of the copolymer, the water-soluble crosslinking agent, and the water sum to at least 90 weight percent, based on the total weight of the textile finishing composition.

9. A finished textile comprising:
a halamine-containing coating disposed on at least a portion of a surface of a textile, wherein the halamine-containing coating is derived from the textile finishing composition of claim 1.

10. The finished textile of claim 9, wherein the textile is a natural textile or a synthetic textile.

11. The finished textile of claim 9, wherein the textile comprises a polyester, a polyamide, a polyacrylate, or a combination thereof.

12. The finished textile of claim 9, wherein the finished textile is prepared by a continuous dip-pad-dry-cure-halogenation process.

13. The finished textile of claim 9, wherein the finished textile is anti-bacterial, anti-fungal, anti viral, or a combination thereof.

14. The finished textile of claim 9, wherein an anti-microbial function of the finished textile can be monitored by a color-based assay.

15. The finished textile of claim 9, wherein the anti-microbial function of the finished textile is durable upon washing.

16. The finished textile of claim 9, wherein the anti-microbial function of the finished textile can be regenerated by treating with halogen-containing agents.

17. A method of finishing a textile, the method comprising:
applying the textile finishing composition of claim 1 to the textile;
padding the textile;
drying the textile to provide a coated textile;
curing the coated textile under conditions effective to react the crosslinking agent with the carboxylic acid groups of the copolymer; and
halogenating the coated textile to provide a finished textile having a halamine-containing coating disposed on at least a portion of a surface of the textile.

18. The method of claim 17, wherein applying the textile finishing composition comprises continuously dipping the textile into a finishing bath comprising the textile finishing composition.

19. A method of determining anti-microbial properties of a finished textile, the method comprising:
contacting the finished textile of claim 9 with a compound capable of reacting with a halogen to cause a color change to provide a colorimetric assessment of active halogen content of the finished textile.
